(19) United States
(12) Patent Application Publication
(10) Pub. No.: US 2016/0118647 A1
(43) Pub. Date: Apr. 28, 2016

(54) CARBONOUS COMPOSITE MATERIAL MADE WITH AND FROM PINE TREE NEEDLES AND ITS USE IN AN ENERGY CELL

(71) Applicant: Bindia Bhagat, Ithaca, NY (US)

(72) Inventor: Bindia Bhagat, Ithaca, NY (US)

(21) Appl. No.: 14/523,920

(22) Filed: Oct. 26, 2014

(51) Int. Cl. H01M 4/36; H01M 4/58; H01M 4/66; C01B 31/36; H01M 4/587; H01M 4/62

(52) U.S. Cl. CPC H01M 4/364; H01M 4/587; H01M 4/62; H01M 4/666; C01B 31/36; H01M 4/58; H01M 2004/027

(57) ABSTRACT

1. The specification relates to a carbonous composite particle made from pine tree needles or other natural leaves of composition CM for use in an energy cell. C is carbon, M is from a group of Sc, Ti, V, Cr, Mn, Fe, Co, Ni, Cu, Zn, Zr, Mo, Pd, Ag, W, Al, N, C, B, O, F, Si, P, Cl, Ga, Sn, Li, Na, K, Mg, Ca, Sr. Energy cell is lithium ion or sodium ion or lithium sulfur or lithium air or rechargeable cell or primary cell or electrochemical cell or fuel cell or magnesium cell or solar cell or capacitor or super-capacitor or hybrid cells or alkaline cell or lead acid cell or metal hydride or nickel cadmium or combination of thereof.

### CROSS REFERENCE TO RELATED APPLICATIONS

This application claims priority to U.S. Provisional Patent No. 61/896,106 filed on 27 Oct. 2013.

### BACKGROUND

The disclosed technology relates to carbonous or composite particles used to store ions such as in a rechargeable electrochemical cell or primary cell or capacitor or fuel cell or battery or a combination thereof. Conventionally, electrochemical cell use graphite or other carbon-based materials obtained majorly from crude oil, naturally occurring rocks etc. Graphitic carbon has historically performed well due to its low voltage vs. lithium, high conductivity, decent cycle life and wide availability. However, only limited raw materials are used to manufacturer the graphitic or other form of carbon.

The current technology relates generally to the synthesis of an anode material, anode additive, cathode additive, current collector, binder, electrolyte additive and in an embodiment more particularly to composite materials and flexible current collector to store electrochemically active ions like lithium, sodium and potassium as in a rechargeable electrochemical cell, or carbon agent or constituting chemical and a method of preparing the same, and an energy cell, including but not limited to rechargeable cell or primary cell or electrochemical cell or fuel cell or capacitor or super-capacitor or hybrid cells or lead acid cell or metal hydride or nickel cadmium or combination of thereof, comprising the same.

The current technology describes a unique approach of making better and long-term use of biological waste like pine needles or pine leaf into energy storage material. Such material can be used in electrochemical cells such as but not limited to Lithium ion battery, Lithium air battery, Lithium sulfur battery, sodium ion battery, magnesium ion battery, rechargeable cell or primary cell or electrochemical cell or fuel cell or capacitor or super-capacitor or hybrid cells or lead acid cell or metal hydride or nickel cadmium or combination of thereof.

The present invention relates generally to the carbonous and in an embodiment more particularly to composite materials on a carbon current collector or metal current collector to store eletroactive ions or react with other part of chemical in energy cell such as in a rechargeable cell or primary cell or electrochemical cell or fuel cell or capacitor or super-capacitor or hybrid cells or combination of thereof made from this, a method of preparing the same, and a rechargeable flexible electrochemical cell comprising the same and its used in flexible portable electronics, flexible computes, flexible home appliances, aviation, ship and electric vehicles, electric bikes, electric solar vehicles, electric solar bikes, hybrid vehicles, medical devices, and hybrid energy storages. But this use is not limited to the applications just mentioned here.

The current material can also be used as additive for primary and secondary batteries as diagnostic material to stop the unwanted side reactions, which eventually enhances the electrochemical performance of the cell or battery. Such performance could be overall energy capacity, power, internal resistance, impedance, cycle life, calendar life etc.

The current technology relates generally to the synthesis of an anode material more particularly to composite materials containing one or more elements from Ti, V, Cr, Mn, Fe, Co, Ni, Cu, Zn, Zr, Mo, Pd, Ag, W, Al, N, C, B, O, F, Si, P, CI, Ga, Sn, Li, Na, K, Mg, Ca, and Sr and can store electrochemically active ions like lithium, sodium and potassium as in a rechargeable electrochemical cell, a method of preparing the same, and a rechargeable electrochemical cell comprising the same.

There are several classes of carbon materials. For example, one kind of carbon is just used as additive on cathode as well as anode side of an electrochemical cell. This carbon has more of a conductive feature than ionic storage feature. On the other hand carbonous material like graphite or graphene or nano-carbon is used just as anode. However in real sense to make it a green technology very rare attempts are made to manufacture these materials from biological waste in particular pine tree needles.

Another class of usability of such carbonous material or composite is to replace existing metal current collectors with high strength carbonous sheets. Carbonous material obtained from pine tree needle can be tailored into composite sheet which is not only as conductive but also mechanically stable enough to replace existing current collectors such as copper and aluminum etc. This can also help making flexible electronics and energy cells for flexible electronics.

This carbonous or composite material may be formed by addition of compounds containing one or more elements from Sc, Ti, V, Cr, Mn, Fe, Co, Ni, Cu, Zn, Zr, Mo, Pd, Ag, W, Al, N, C, B, O, F, Si, P, Cl, Ga, Sn, Li, Na, K, Mg, Ca, and Sr, into the pine needles followed by high speed agitation and heating in inert atmosphere any temperature above 25° C. and below 3000° C. Addition, mixing, heating, grinding and sieving etc. can be done in single or multiple steps.

### SUMMARY

This specification describes technologies relating to carbonous composite particles from pine tree needles for use in an energy cell and a method for making the same. The composite particles of the disclosed technology form a composition that has (i) graphitic carbon to store electrochemically active ions such as lithium, (ii) composite to be used as an anode in energy storage device, (iii) a conductive carbon that can added on cathode or anode part of an electrochemical cell, (iv) carbonous composite to be tailored to replace metallic current collectors in an electrochemical cell and battery and (v) composite containing non carbon metals to enhance the energy storage performance.

The carbonous composite particles of the disclosed technology also has an optimum surface area, with micron size primary particles size being composed of a core composition encased within another composition providing for stable cycling of the cell also enhancing the formation of the SEI layer and stabilizing the SEI layer during cycling.

The carbonous composite particles of the disclosed technology also has a high surface area, with nano size primary particles size being composed of a core composition encased within another composition providing for stable cycling of the cell also enhancing the formation of the SEI layer and stabilizing the SEI layer during cycling.

The structure of the carbonous composite particles possess columns, fibers, needles, flakes, ribbons, belts, sheets, spheres, hollow pipes and hollow spheres etc. arranged in an array such that the crystalline part is crystallographically extend into space thereby providing for a separation between crystallite extensions and/or amorphous part is extended randomly either around crystallite or coated on crystalline and/or amorphous yet chemically different part of particle.

The carbonous composite particles can have (1) at least 2 m2/g of surface area from pure carbonous part, (2) a total surface area of greater than 2m2/g, (3) greater than 50% of the carbonous composite particles having lowest dimensions greater than 2 nano meter, wherein each particle has a length greater than at least 10 times the diameter, and (4) greater than 2% of the crystalline particles being oriented in the same crystallographic direction.

The carbonous composite particle can be formed from, for example a pine tree needle by applying acids or base in a pH controlled environment in the presence of compound containing one or more of elements such as Sc, Ti, V, Cr, Mn, Fe, Co, Ni, Cu, Zn, Zr, Mo, Pd, Ag, W, Al, N, C, B, O, F, Si, P, Cl, Ga, Sn, Li, Na, K, Mg, Ca, and Sr. The light acids or base treatment is terminated upon the formation of the composite and in such a manner as to minimize highly oxidized species and facilitate required morphology within the primary particle.

The carbonous composite particles can also be heated at an elevated temperature under different gas atmospheres to increase electrochemical performance of the composite particles. The composite particles may also be mixed with different grade of carbon material. The carbonous composite material may contain sp2 carbon or conductive carbon or graphitic carbon like carbon black or nano carbon or graphene or graphite or acetylene black or carbon nano tubes or sp1 carbon or sp3 carbon or combination thereof.

In another implementation, an energy cell, like rechargeable cell or primary cell or electrochemical cell or fuel cell or capacitor or super-capacitor or hybrid cells or combination of thereof, comprising the same an anode or cathode or current collector or combination thereof made from carbonous composite and a solvent.

In another implementation, an electrochemical rechargeable cell can comprise a cathode additive made from carbonous composite along with a binder and a solvent.

In another implementation, an electrochemical rechargeable cell can comprise current collector on cathode or anode or both, made from carbonous composite.

### BRIEF DESCRIPTION OF THE DRAWINGS

FIG. 1 is a SEM view of composite carbon described in this invention.

FIG. 2 is a SEM view of an embodiment of the present invention showing the metal particles on composite material surface.

FIG. 3 is a high resolution TEM and EELS showing the presence of metal around composite particle at 5 nm scale.

FIG. 4. Charge discharge voltage verses capacity obtained with half-cell Li-ion cell from composite carbon obtained from pine tree needles.

FIG. 5. Charge and discharge capacity obtained with half-cell Li-ion cell as a function of cycle numbers from composite carbon obtained from pine tree needles.

FIG. 6. Coulombic efficiency obtained with half-cell Li-ion cell as a function of cycle numbers from composite carbon obtained from pine tree needles.

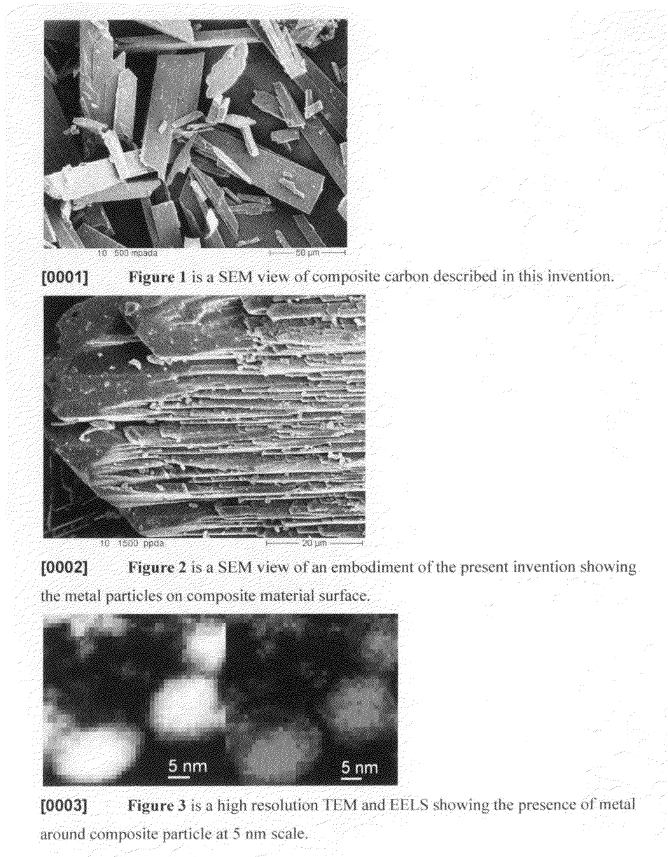

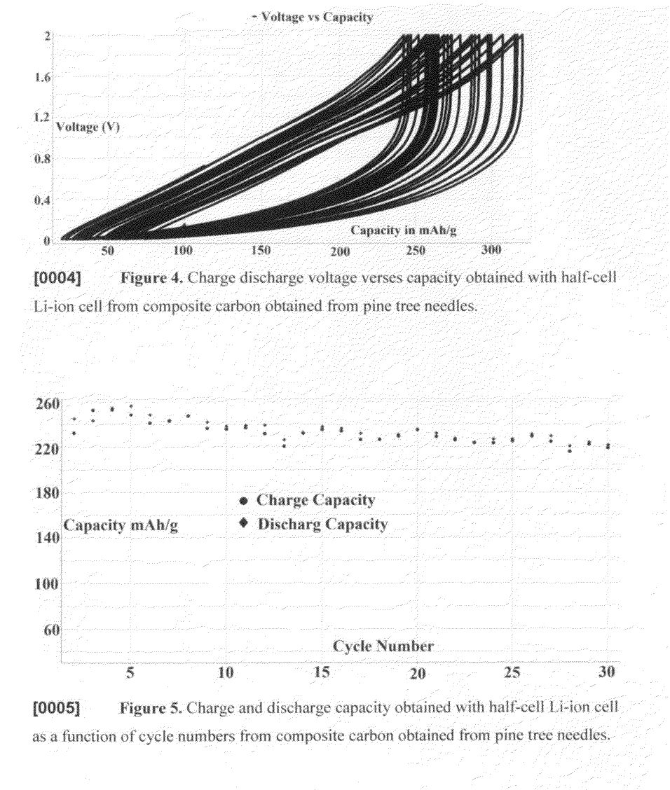

### DETAILED DESCRIPTION

This specification describes technologies relating to carbonous composite particles made from pine tree needles for use in an energy cell (to rechargeable cell or primary cell or electrochemical cell or fuel cell or capacitor or super-capacitor or hybrid cells or combination of thereof) and a method for making the same. The carbonous composite particles of the disclosed technology form a composition that has (i) a surface for easy SEI (solid electrolyte interface) formation, (ii) atomic level solubility of other electrochemically active materials to improve the energy storage and power (iii) a selectively designed surface for electrolyte reactivity, (iv) a substrate made to be used as current collector.

In order for a material to reversibly react with electrochemically active ion such as lithium, without losing energy and to provide a long battery life, the material should be able to form a stable solid electrolyte interface (SEI) from it's first charge/discharge process itself. This SEI should have a suitable thickness and have a textured or modified surface that helps stabilize the material in the cell. In the disclosed technology, the carbonous composite particles possess a surface that helps in creating surface texture and stabilizing an SEI layer.

In the disclosed technology, the carbonous composite particles are formed to minimize pores on the surface of the particles and create spaces between individual crystals of the particles to accommodate the volume change that occurs in electrochemical cell. In other words, the disclosed technology includes methods of synthesis of carbonous composite material in a particulate form having an open structure. These features increase the storing/alloying capacity in an electrode material in an energy cell (including but not limited to rechargeable cell or primary cell or electrochemical cell or fuel cell or capacitor or super-capacitor or hybrid cells or combination of thereof) thus providing a higher energy density, specific capacity and cycle life to the cell.

The disclosed technology found that combining good particle morphology, such as that obtained from pine tree needles or leaf, with morphological features provide for excellent cycling stability. A suitable carbonous composite particle structure can be obtained from a suitable pine tree needle microstructure, sometimes described as “feathery” or more commonly as fibrous. In some implementations, the structure of the carbonous composite can be an extended structure wherein each segment is crystallographically distinct.

In one implementation, a carbonous composite was obtained by selecting a pine tree needle occurring naturally. Pine tree needle, however, is not the only naturally occurring system for which the carbonous phase can be substantially pure and is used in energy cell (to rechargeable cell or primary cell or electrochemical cell or fuel cell or capacitor or super-capacitor or hybrid cells or combination of thereof). Additionally, any naturally occurring leaf containing carbonous material in which carbon is the atomically major constituent (relative to the group of all other elements from periodic table) and in which, upon heating in an atmosphere, the carbon phase remain to greater than 2 wt% is a suitable material for use as electrode or current collector material.

Composite carbonous material is being alloyed or mixed or both with at least one transition metal from first raw transition metals or second raw transition metals or third raw transition metal or fourth raw transition metal or a combination thereof.

Composite carbonous material is being alloyed or mixed or both with at least one transition metal from first raw transition metals or second raw transition metals or third raw transition metal or fourth raw transition metal or a combination thereof. Such mixture or alloy in the form of a particle can have a shape which is spherical, platelet or flaky or diamond or rod or cylindrical or octahedron or dodecahedrons or double pyramids or prisms or rhombic prisms or hexagon or donut or hollow sphere or a combination there of.

The composite carbonous material should include an amorphous or crystalline component. It may contains different forms of hard carbon, soft carbon, graphitic carbon, nano carbon, diamond, nano tubes, nano rods or other form of nano carbon. This ratio varies as the treatment temperature of the pine tree needles is varied or the gaseous atmosphere for heat treatment is changed. The gas can be inert of reactive in nature.

If other gases like HF or CF4 or other halide containing compounds is used, the resulting material forms CFx. This is another energy storage material.

In a preferred implementations, the composite carbonous material can include 90 wt % Carbon, 10 wt % non carbon elements, which can be metals or non metals or combination there of. The resultant composite can be described as a metal/carbon matrix, a carbon metal matrix or a carbonous composite material. The composite carbon may be in the form of a powder or slurry or dispersion or combination thereof.

In some implementations, the composite carbonous material can contain at least 1 wt % carbon in which the surface area is greater than 1 m2/g and in which at least 1% of the composite particles has the same crystallographic orientation.

In some implementations, heating composite carbonous particle at an elevated temperatures for more than 1 minute (90° C. or higher) under different atmospheres (air or oxygen or nitrogen or He/H2 or argon or combinations) increases electrochemical performance of material by greater than 2%. That is, controlled heating of liberated composite carbonous particle for more than 1 minute (100° C. or 200° C. or 300° C. or 400° C. or 600° C. or 1100° C. higher) under different atmospheres (air or oxygen or nitrogen or He/H2 or argon or combinations) followed by other dissolution treatments can increase the specific capacity of the composite by 10%. In a preferred implementation, the composite was heated at 700 degrees in nitrogen. In another implementation, the composite was heated at 600 degrees in a 100% Nitrogen rich environment.

In some implementations, the density of the material can be adjusted based on choice of size of pine needles, for instance the electrode density can be varied between 0.6-3 g/cc if chopped needles are used. The final product BET or surface area of the particles can be varied between 10 to 300 m2/g.

In one implementation, a process to synthesize a composite structure where the structure is formed by using at least a metal combinations/alloys/intermetallics as one phase and pine tree needles as other phase, resulting in carbonous part in atomic majority to creating a metal/metal oxide/carbon composite using an acid or an acid/base mixture where the other metallic element which is in atomic minority, where the composite particle obtained can be used in an energy cell (lithium ion cell, sodium ion cell, lithium sulfur cell, lithium air cell, rechargeable cell or primary cell or electrochemical cell or fuel cell or capacitor or super-capacitor or hybrid cells or alkaline cell or lead acid cell or metal hydride or nickel cadmium or combination of thereof etc.).

In another implementation, a carbonous composite particle can be used to make a flexible energy cell of a battery. Particle can be coated on a flexible substrate or can self be used to make a flexible substrate to be used as current collector in an energy cell such as lithium ion cell, sodium ion cell, lithium sulfur cell, lithium air cell, rechargeable cell or primary cell or electrochemical cell or fuel cell or capacitor or super-capacitor or hybrid cells or alkaline cell or lead acid cell or metal hydride or nickel cadmium or combination of thereof etc.

In another implementation, a particle can be used to make flexible electrochemical cell of a nano size where one of the minimum dimensions is more than 5 nanometer and maximum dimension is less than 1000 nanometer.

In another implementation, a particle can be used to make flexible electrochemical cell of a micron size where one of the minimum dimensions is more than 1 micron and maximum dimension is less than 1000 micron.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

In an example, carbonous composite was synthesized by taking 500 gm of dry pine needles in a 2.5 Liters sealed oven filled with nitrogen. Oven is then heated slowly to a temperature of 700 C and kept at 700 C for 1 hour. The carbonous material taken out was then milled and sieved to have homogenous size particles.

### Example 2

In an effort to form another type of carbonous composite, 5 gm of silicon alloy of particle size 1-50 micron was dry mixed with 100 g of chopped pine needles. This mixture was then intermittently added into 2 liter of 1M NaOH for 24 hours. After that solid was filtered followed by washing with acetone and then milled/sieved to convert into a homogeneous powder.

### Example 3

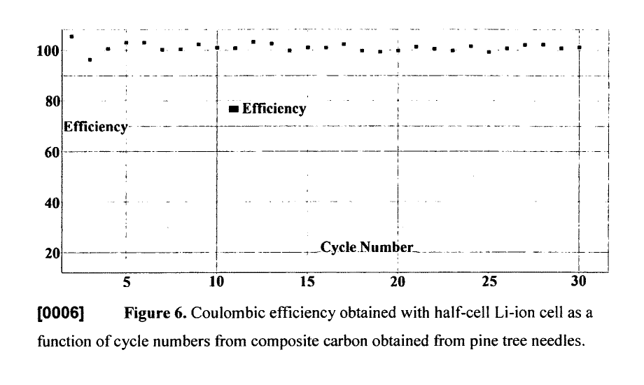

The obtained carbonous composite of Example 2 was blended with SuperP carbon and ammonium alginate binder or LiPAA or SBR or a mixture there of in a weight ratio of 80:11:10. De-ionized water was used to make a slurry in Teflon vial with zirconia media (1:3 weight ratio) and milled for 2 hours, which later casted on a copper foil or carbonous composite paper made from the material explained in Example 1; the casting was cut into 1.3 cm2 circular electrodes and dried overnight at 100° C. in air. Active loading of around 6˜9 mg/cm2 was achieved. Lithium foil was used as the counter electrode for the electrochemical testing. The electrolyte was 1 M LiPF6 dissolved in a 1:1 mixture of EC/DMC with 4 wt. % FEC. The coin cell was cycled between various cut off voltages including, 0.01 V-1.5 V, 0.07V-1.5 V, 0.1 V-1.5 V and 0.15 V-1.5 V. All results show the capacity of minimum 200 mAh/gm with 90% cycling efficiency after 30 cycles as shown in FIG. 6.

### Example 4

In an example, mineralized carbonous composite was synthesized by taking 500 gm of dry pine needles and 400 gm of fishmeal in a 2.5 Liters sealed oven filled with nitrogen. Oven is then heated slowly to a temperature of 500 C and kept at 500 C for 1 hour. The mixture was then milled with high energy milling with zirconium balls for an hour. Mixture was then again heated at 700 C for an hour and then cooled slowly. The carbonous material taken out was then milled and sieved to have homogenous size particles.

Cell made as in Example 3 with Lithium counter electrode or other counter electrode such as Olivine type, Spinel type or layered type materials or combination thereof. These cells then connected in series and parallel to make a battery. Such battery is used as energy storage device that is used in solar electric bike. Solar electric bike is just an example and doesn't limit the use of this material for other applications.

I claim:

1. A particle of a carbonous composite composition obtained from pine tree needles for use in an energy cell, the composite comprising a general formula of CM, wherein C is carbon and M is from a group of Sc, Ti, V, Cr, Mn, Fe, Co, Ni, Cu, Zn, Zr, Mo, Pd, Ag, W, Al, N, C, B, O, F, Si, P, Cl, Ga, Sn, Li, Na, K, Mg, Ca, and Sr.

2. The particle of claim 1 wherein C is at least 0.01% (by weight) and M is at least 0.01% by weight in composite.

3. The particle of claim 1 where needles or leaves are from pinophyta or coniferophyta or coniferae division of kingdom plantae. It would also include plants from other divisions with needle shaped leaves.

4. The particle of claim 1 wherein the energy cell is lithium ion or sodium ion or lithium sulfur or lithium air or rechargeable cell or primary cell or electrochemical cell or fuel cell or magnesium cell or solar cell or capacitor or super-capacitor or hybrid cells or alkaline cell or lead acid cell or metal hydride or nickel cadmium or combination of thereof etc.

5. The composite composition of claim 1 wherein the particle is synthesized by acidic or basic treatment to pine leaf comprising at least one M from claim 1, the treatment is performed chemically with one or more light acids, organic acids, an alkali and/or an ionic solution.

6. The composite composition of claim 1 for use in an electrochemical cell comprising: a major dimension of the composite composition particles being less than 500 microns and minor dimension more than 0.1 nanometer.

7. The material in claim 1 where at least 1% of crystallites being oriented in the same crystallographic plane.

8. The material in claim 1 is mixed as an additive in cathode or anode or both of an energy cell. Energy cell is defined as is lithium ion or sodium ion or lithium sulfur or lithium air or rechargeable cell or primary cell or electrochemical cell or fuel cell or capacitor or super-capacitor or hybrid cells or alkaline cell or lead acid cell or metal hydride or nickel cadmium or combination of thereof etc.

9. The material in claim 1 is used in making paper or substrate or current collector that is used in an energy cell. Energy cell is energy cell is lithium ion or sodium ion or lithium sulfur or lithium air or rechargeable cell or primary cell or electrochemical cell or fuel cell or magnesium cell or solar cell or capacitor or super-capacitor or hybrid cells or alkaline cell or lead acid cell or metal hydride or nickel cadmium or combination of thereof etc.

10. The material in claim 1 is used in energy cell that is further used in applications, not limited to, such as flexible portable electronics, non-flexible portable electronics, flexible and non-flexible computes, flexible and non-flexible home appliances, aviation, ship and electric vehicles, electric bikes, electric solar vehicles, electric solar bikes, hybrid vehicles, medical devices, satellites, power backup, energy storage system and hybrid energy storages tanks.

11. The material is claim 1 where at least 0.05% of the weight has an amorphous phase.

12. The material is claim 1 where at least 0.05% of the weight has a crystalline phase.

13. The material is claim 1 where CM composite is heated at an elevated temperature under different atmospheres to increase electrochemical or energy storage performance.

14. The material is claim 1 where carbon is either sp1 or sp2 or sp3 or combination thereof.

15. A particle of a carbonous composite composition obtained from pine tree needles, where the composite comprising a general formula of CM, wherein C is carbon and M is from a group of Sc, Ti, V, Cr, Mn, Fe, Co, Ni, Cu, Zn, Zr, Mo, Pd, Ag, W, Al, N, C, B, O, F, Si, P, Cl, Ga, Sn, Li, Na, K, Mg, Ca, and Sr.

16. The material in claim 14 is used in non-energy cell applications, including but not limited to, fluid filtration, oil filtration, water filtration, tire manufacturing, polymer composite formation, gas storage, polish, lubrication, pencil, steel production, nanotube formation, graphene formation, medicine etc.
